(19) United States
(12) Patent Application Publication
(10) Pub. No.: US 2026/0177765 A1
(43) Pub. Date: Jun. 25, 2026

(54) COMPONENT COUPLING APPARATUS

(71) Applicant: ALL RING TECH CO.,LTD., Kaohsiung City (TW)

(72) Inventors: Chun-Hung TSAI, Kaohsiung City (TW); Heng-Hui LIU, Kaohsiung City (TW); Yu-Sheng GUO, Kaohsiung City (TW); Li-Hsin CHEN, Kaohsiung City (TW)

(21) Appl. No.: 19/347,122

(22) Filed: Oct. 1, 2025

(30) Foreign Application Priority Data
Dec. 20, 2024 (TW) 113150073

(51) Int. Cl. G02B 6/42

(52) U.S. Cl. CPC G02B 6/4221

(57) ABSTRACT

A component coupling apparatus is adapted to be disposed on a machine bed and includes a first stage device, a second stage device, an adhesive coating device, and at least one component coupling device. The first stage device includes a first stage adapted to carry an integrated circuit component. The second stage device includes a second stage adapted to carry a fiber array unit. The adhesive coating device includes a first adhesive valve adapted for coating a first adhesive onto the fiber array unit. The at least one component coupling device includes a retention mechanism adapted to retain the fiber array unit. The retention mechanism is operable to drive the fiber array unit to move sequentially among the second stage, the adhesive coating device, and the first stage.

### CROSS-REFERENCE TO RELATED APPLICATION

This application claims priority to Taiwanese Invention Patent Application No. 113150073, filed on Dec. 20, 2024, the entire disclosure of which is incorporated by reference herein.

### FIELD

The disclosure relates to a component coupling apparatus, and more particularly to a component coupling apparatus for coupling a fiber array unit to an integrated circuit component.

### BACKGROUND

In a semiconductor manufacturing process, in order to produce chips that have relatively high transmission performance and relatively low power consumption, silicon photonics (SiPh) technology has become the focus of industry development. In silicon photonics technology, such as a pluggable transceiver optics (PTO) infrastructure, an on-board optics (OBO) infrastructure, a co-packaged optics (CPO) infrastructure and an optical input/output (optical I/O) infrastructure, it is necessary to couple a fiber array unit (FAU) to an integrated circuit component. Currently, the process of integrated circuit component packaging has progressed to two-point-five dimensional (2.5D) IC packaging and three-dimensional (3D) IC packaging, and integrated circuit components and fiber optic array units have also been modified in structure with the advancement of the process of integrated circuit component packaging. For example, the integrated circuit component includes photonic integrated circuits (PIC), and the fiber array unit includes optical couplers, receptacle portions and optical fibers that are connected between the optical couplers and the receptacle portions. The photonic integrated circuits of the integrated circuit component are coupled to the optical couplers of the fiber array unit and are in optical communication with the external environment through the optical fibers of the fiber array unit.

When operations for coupling the fiber array unit to the integrated circuit component are performed, the fiber array unit is usually adhered to the integrated circuit component by adhesive. First, an adhesive valve, which is movable in multi-directions, is driven to move to a position above the integrated circuit component. Then, an adhesive is applied to a coupling position on the integrated circuit component that is to be coupled to the fiber array unit. Finally, a retention mechanism picks up the fiber array unit to move the same onto the adhesive. However, since the adhesive valve and the retention mechanism are sequentially and individually moved toward the integrated circuit component, structural complexity and set up costs are increased and an accurate application of the adhesive to the coupling position by the adhesive valve is relatively difficult. Consequently, there may be no adhesive disposed between the integrated circuit component and the fiber array unit, which adversely affects coupling therebetween.

### SUMMARY

Therefore, an object of the present disclosure is to provide a component coupling apparatus that can alleviate at least one of the drawbacks of the prior art.

According to an aspect of the disclosure, a component coupling apparatus is adapted to be disposed on a machine bed. The component coupling apparatus includes a first stage device, a second stage device, an adhesive coating device, and at least one component coupling device. The first stage device includes a first stage adapted to carry an integrated circuit component. The second stage device includes a second stage adapted to carry a fiber array unit. The adhesive coating device includes a first adhesive valve adapted for coating a first adhesive onto the fiber array unit. The at least one component coupling device includes a retention mechanism adapted to retain the fiber array unit. The retention mechanism is operable to drive the fiber array unit to move sequentially among the second stage, the adhesive coating device, and the first stage.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of an integrated circuit component and an fiber array unit to be coupled to the integrated circuit component by an embodiment of a component coupling apparatus according to the present disclosure.

FIG. 2 is a fragmentary schematic section view illustrating the fiber array unit coupled to the integrated circuit component.

FIG. 3 is a perspective view of the fiber array unit.

FIG. 4 is a perspective view of the fiber array unit seen from an angle different from FIG. 3.

FIG. 5 is a fragmentary, partly sectional view illustrating an optical signal transmitted between the fiber array unit and the integrated circuit component.

FIG. 6 is a block diagram illustrating the embodiment of the component coupling apparatus according to the present disclosure.

FIG. 7 is a schematic top view illustrating arrangement relationships of elements of the embodiment of the component coupling apparatus.

FIG. 8 is a perspective view illustrating a component coupling device of the embodiment of the component coupling apparatus.

FIG. 9 is a partly exploded perspective view illustrating a third straight movement unit of the first drive mechanism, a second drive mechanism, a retention mechanism, and an inspection mechanism of the embodiment of the component coupling apparatus.

FIG. 10 is a partly exploded perspective view illustrating a first rotatable assembly, a second rotatable assembly, and a third rotatable assembly of the second drive mechanism.

FIG. 11 is a perspective view illustrating a first movable seat of the first rotatable assembly rotatable about a first axis along a first arcuate path relative to a first base seat of the first rotatable assembly.

FIG. 12 is a perspective view illustrating a second movable seat of the second rotatable assembly rotatable about a second axis along a second arcuate path relative to a second base seat of the second rotatable assembly.

FIG. 13 is a perspective view illustrating a third movable seat of the third rotatable assembly rotatable about a third axis along a third arcuate path relative to a third base seat of the third rotatable assembly.

FIG. 14 is a fragmentary side view illustrating a plurality of connection surfaces of the second drive mechanism.

FIG. 15 is a fragmentary perspective view illustrating the first axis, the second axis, and the third axis intersecting at an axial point.

FIG. 16 is a partly exploded perspective view of the retention mechanism and a curing unit of the retention mechanism.

FIG. 17 is a fragmentary side view illustrating the retention mechanism and an air passage of the retention mechanism.

FIG. 18 is a fragmentary side view illustrating a retention member of the retention mechanism.

FIG. 19 is a fragmentary perspective view illustrating the retention member that is disposed upside down.

FIG. 20 is a perspective view of a drive unit of the retention mechanism.

FIG. 21 is a perspective view of a connector member of the retention mechanism.

FIG. 22 is a fragmentary schematic side view illustrating the connector member being movable relative to the retention member and adapted to be detachably connected to the fiber array unit.

FIG. 23 is a fragmentary schematic perspective view illustrating two first light sources of the curing unit emitting an ultraviolet light toward the fiber array unit.

FIG. 24 is a schematic side view illustrating the retention mechanism moving the fiber array unit to a detection device of the embodiment of the component coupling apparatus.

FIG. 25 is a schematic side view illustrating the retention mechanism moving the fiber array unit to an adhesive coating device of the embodiment of the component coupling apparatus.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

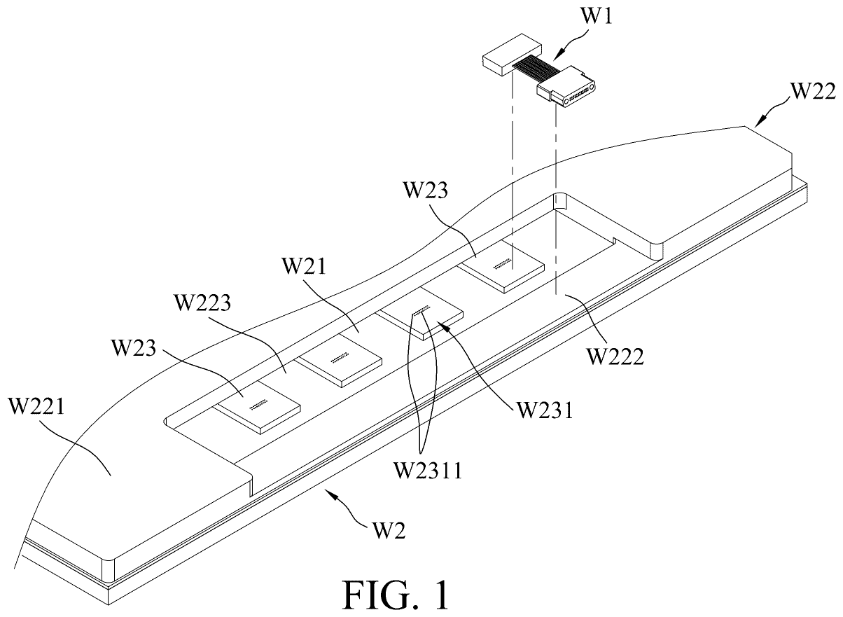

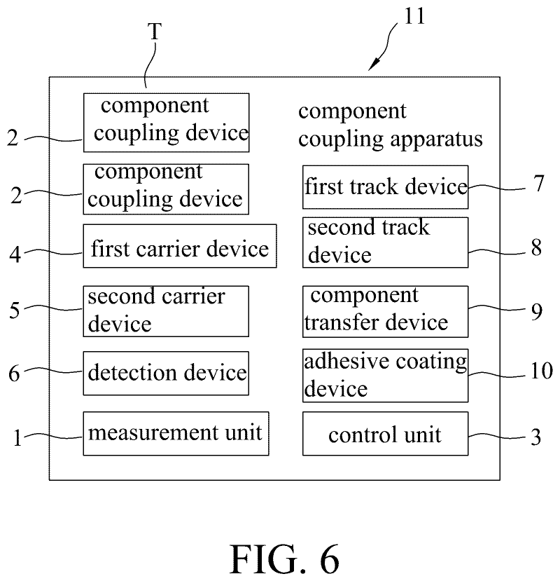

Referring to FIG. 1, a fiber array unit (W1) is to be coupled to an integrated circuit component (W2) by an embodiment of a component coupling apparatus 11 according to the present disclosure shown in FIG. 6.

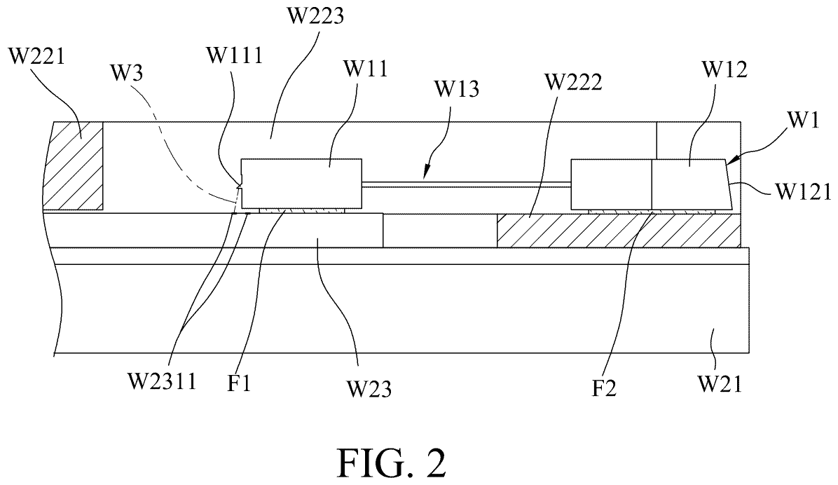

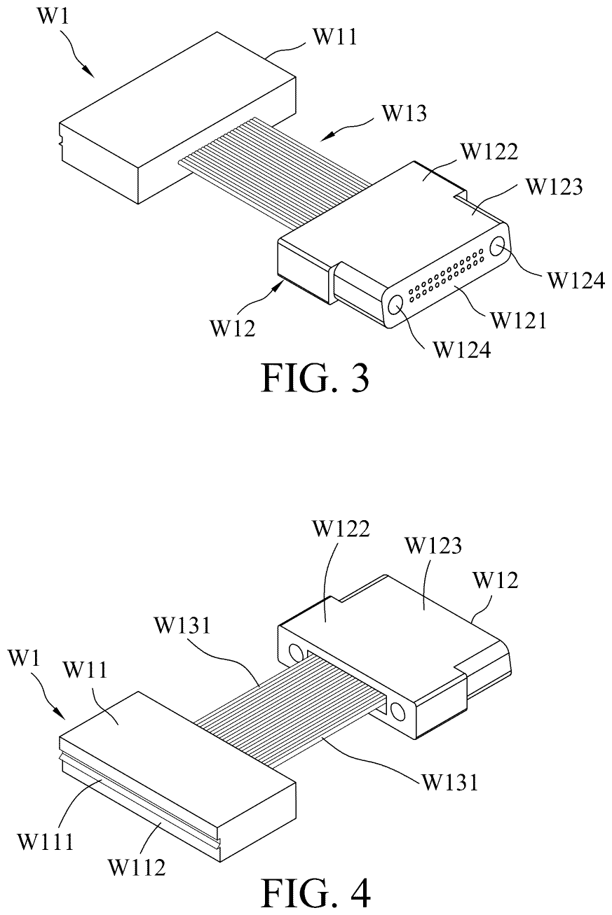

Further referring to FIGS. 2 to 4, the fiber array unit (W1) includes an optical coupler (W11), a receptacle portion (W12), and an optical fiber portion (W13) connected to the optical coupler (W11) and the receptacle portion (W12). The optical coupler (W11) is made of a light-transmissive material and includes a prism (W111) that is formed on a first side surface (W112) of the optical coupler (W11) which is distal from the receptacle portion (W12). The receptacle portion (W12) is provided for the optical fiber portion (W13) to extend therethrough such that the optical fiber portion (W13) is exposed outwardly of a second side surface (W121) of the receptacle portion (W12) that is distal from the optical coupler (W11). The receptacle portion (W12) includes a first seat portion (W122), a second seat portion (W123) having a width smaller than a width of the first seat portion (W122) in a direction transverse to a direction that the optical fiber portion (W13) extends in, and two guide holes (W124) extending through the first seat portion (W122) and the second seat portion (W123). As shown in FIG. 2, the second side surface (W121) of the receptacle portion (W12) is tilted outwardly from top to bottom. The optical fiber portion (W13) includes a plurality of optical fibers (W131) and is flexible.

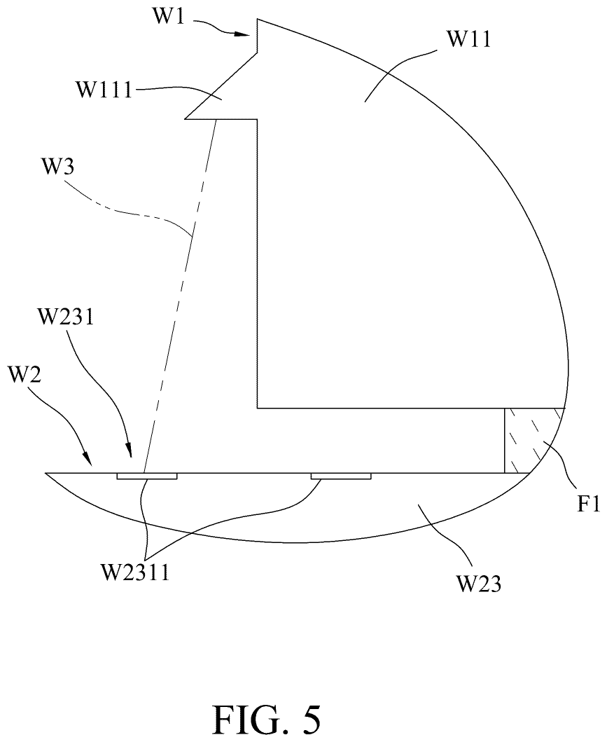

Referring back to FIGS. 1 and 2, the integrated circuit component (W2) includes a carrier board (W21), a lid unit (W22), and a plurality of photonic integrated circuits (W23) disposed on the carrier board (W21). The carrier board (W21) is substantially rectangular and the photonic integrated circuits (W23) are arranged on one side of the carrier board (W21). The lid unit (W22) includes a first lid portion (W221), a second lid portion (W222) that is lower in height than the first lid portion (W221), and a recess portion (W223) that is disposed between the first lid portion (W221) and the second lid portion (W222) and that exposes the photonic integrated circuits (W23) therefrom. The recess portion (W223) may be formed according to a design of positions of the photonic integrated circuits (W23). For example, in some embodiments, there are a plurality of recess portions (W223) disposed adjacent to four sides of the carrier board (W21) that is rectangular. Each of the photonic integrated circuits (W23) includes a lens array (W231). As shown in FIGS. 2 and 5, the lens array (W231) includes a plurality of lenses (W2311) that are arranged as a matrix. It should be noted that since the structures of the photonic integrated circuits (W23) are the same, only one of the photonic integrated circuits (W23) will be described in the following description for the sake of brevity.

Referring to FIGS. 2 and 5, when the fiber array unit (W1) is coupled to the integrated circuit component (W2), the optical coupler (W11) of the fiber array unit (W1) is in contact with and abuts against the photonic integrated circuit (W23) and the receptacle portion (W12) is in contact with the second lid portion (W222) of the lid unit (W22). The prism (W111) of the optical coupler (W11) of the fiber array unit (W1) is disposed to correspond in position to the lens array (W231) of the photonic integrated circuit (W23) such that an optical signal (W3) is transmitted between the prism (W111) of the fiber array unit (W1) and the lens array (W231) of the photonic integrated circuit (W23). The optical signal (W3) is outputted from a measurement unit 1 (see FIG. 6) and is transmitted to the fiber array unit (W1). The measurement unit 1 is configured to measure an intensity of the optical signal (W3) transmitted from the measurement unit 1 to the integrated circuit component (W2) and then transmitted back to the fiber array unit (W1). Specifically, the optical signal (W3) outputted from the fiber array unit (W1) is refracted by the prism (W111) and propagates inclinedly, forwardly and downwardly as depicted in FIG. 5 to enter the lenses (W2311) of the lens array (W231). The optical coupler (W11) and the photonic integrated circuit (W23) may be connected to each other by a first adhesive (F1), and the receptacle portion (W12) and the second cover (W222) may be connected to each other by a second adhesive (F2). A shrinkage rate after curing of the first adhesive (F1) is smaller than a shrinkage rate after curing of the second adhesive (F2), and a strength of the second adhesive (F2) that is cured is greater than a strength of the first adhesive (F1) that is cured. In this embodiment, the first adhesive (F1) is an ultraviolet cured adhesive, and the second adhesive (F2) is a heat cured adhesive. It should be noted that, in other embodiments of the present disclosure, the second lid portion (W222) may be omitted and the lid unit (W22) may only include the first lid portion (W221), so that the receptacle portion (W12) is in contact with and abuts against the carrier (W21).

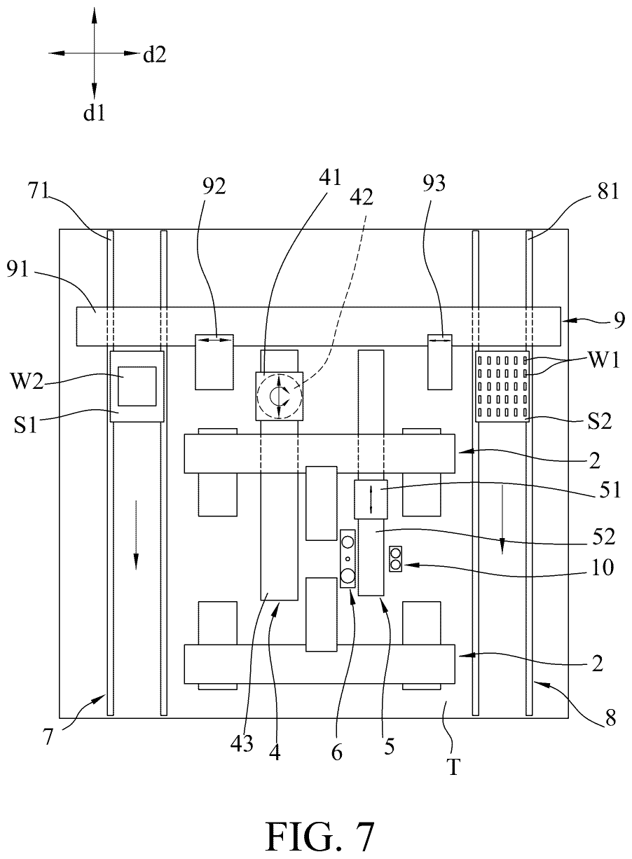

Referring to FIGS. 6 and 7, the embodiment of the component coupling apparatus 11 according to the present disclosure is adapted to be disposed on a machine bed (T) and is adapted to couple the fiber array unit (W1) to the integrated circuit component (W2). The component coupling apparatus 11 includes the measurement unit 1, two component coupling devices 2, a control unit 3, a first stage device 4, a second stage device 5, a detection device 6, a first track device 7, a second track device 8, a component transfer device 9 and an adhesive coating device 10. The component coupling devices 2 are adapted to be disposed on the machine bed (T) and are disposed to face each other. It should be noted that the number of the component coupling devices 2 is not limited to two, and may be one or more than two in other embodiments of the present disclosure. In the following description, since the structures of the component coupling devices 2 are identical, only one of the component coupling devices 2 will be described for the sake of brevity.

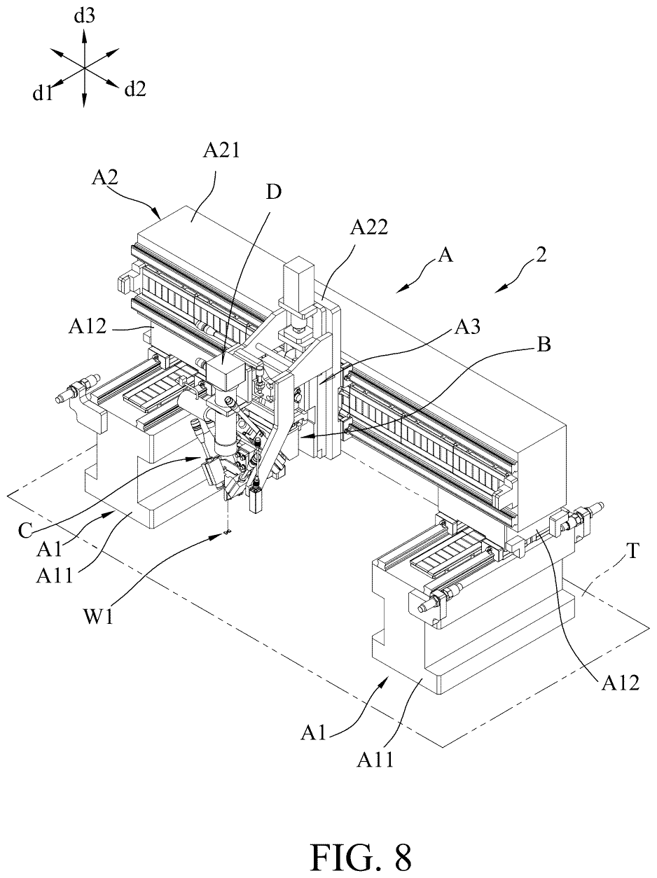

Referring to FIGS. 7 and 8, the component coupling device 2 is adapted to retain and move the fiber array unit (W1), and to couple the fiber array unit (W1) to the integrated circuit component (W2). Specifically, the component coupling device 2 includes a first drive mechanism (A), a second drive mechanism (B), a retention mechanism (C), and an inspection mechanism (D). The first drive mechanism (A) is disposed on the machine bed (T). The second drive mechanism (B) is disposed on the first drive mechanism (A) and is driven by the first drive mechanism (A) to move linearly in a plurality of directions. The retention mechanism (C) is disposed on the second drive mechanism (B) and is driven by the second drive mechanism (B) to rotate about a plurality of axes. The retention mechanism (C) is adapted to retain the fiber array unit (W1) and is driven to move linearly and rotate respectively by the first drive mechanism (A) and the second drive mechanism (B). The inspection mechanism (D) is disposed on the first drive mechanism (A) and is driven by the first drive mechanism (A) to move linearly in the plurality of directions and adapted for inspection of the integrated circuit component (W2) (see FIG. 1).

Referring to FIG. 8, in the following description, a first direction (d1) is a horizontal direction, a second direction (d2) is another horizontal direction normal to the first direction (d1), and a third direction (d3) is a vertical direction normal to the first direction (d1) and the second direction (d2). In this embodiment, the first direction (d1) is a front-rear direction, the second direction (d2) is a left-right direction, and the third direction (d3) is an up-down direction.

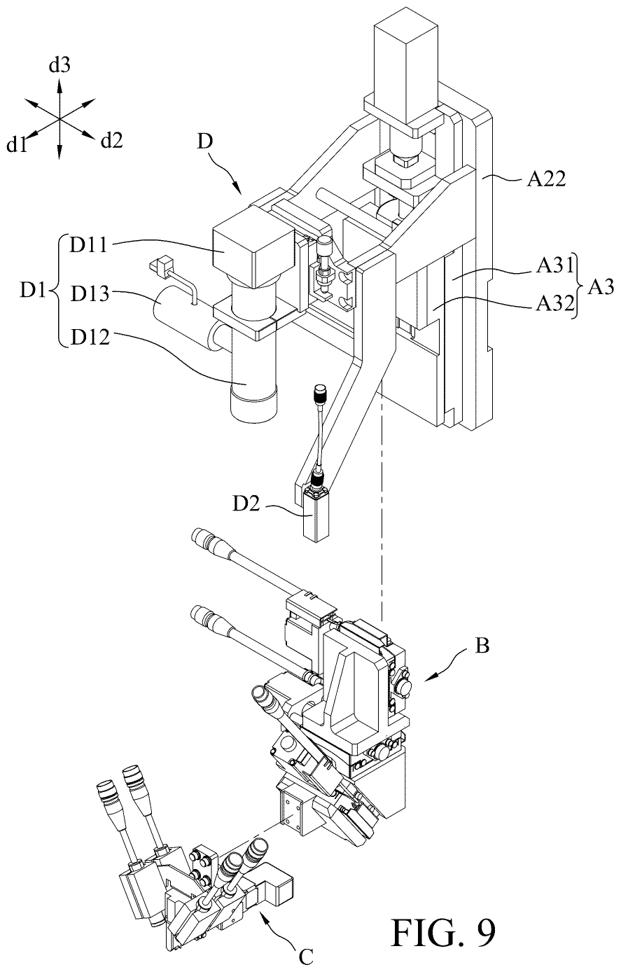

Referring to FIGS. 8 and 9, the first drive mechanism (A) includes a first straight movement unit (A1) disposed on the machine bed (T), a second straight movement unit (A2) mounted to the first straight movement unit (A1), and a third straight movement unit (A3) mounted to the second straight movement unit (A2). The first straight movement unit (A1) is operable to drive the second drive mechanism (B) to move linearly in the first direction (d1), and includes two first rail seats (A11) disposed on the machine bed (T) and spaced apart from each other in the second direction (d2) and two first slide seats (A12) disposed respectively on the first rail seats (A11). The first rail seats (A11) extend in the first direction (d1), and each of the first slide seats (A12) is movable along the respective one of the first rail seats (A11) in the first direction (d1). The second straight movement unit (A2) is operable to drive the second drive mechanism (B) to move linearly in the second direction (d2), and includes a second rail seat (A21) disposed across the first slide seats (A12), and a second slide seat (A22) mounted to the second rail seat (A21). The second rail seat (A21) extends in the second direction (d2), and the second slide seat (A22) is movable along the second rail seat (A21) in the second direction (d2). The third straight movement unit (A3) is operable to drive the second drive mechanism (B) to move linearly in the third direction (d3), and includes a third rail seat (A31) mounted to the second slide seat (A22) and a third slide seat (A32) mounted to the third rail seat (A31). The third rail seat (A31) extends in the third direction (d3), and the third slide seat (A32) is movable along the third rail seat (A31) in the third direction (d3). One or more of the first straight movement unit (A1), the second straight movement unit (A2), and the third straight movement unit (A3) drives the second drive mechanism (B) to move linearly such that the retention mechanism (C) drives linear movements of the fiber array unit (W1) in one or more of the first direction (d1), the second direction (d2), and the third direction (d3). In this embodiment, the first straight movement unit (A1) and the second straight movement unit (A2) employ linear motors to drive movements of the first slide seat (A12) and the second slide seat (A22), but the present disclosure is not limited thereto. In other embodiments, a combination of a screw rod and a rotary motor may be utilized to drive movement of the first slide seat (A12) and the second slide seat (A22). It should be noted that in this embodiment, the third straight movement unit (A3) drives movement of the third slide seat (A32) through a combination of a rotary motor and a screw rod, but the present disclosure is not limited thereto. For example, the third straight movement unit (A3) may drive movement of the third slide seat (A32) through a linear motor in other embodiments of the present disclosure.

Referring to FIG. 9, the inspection mechanism (D) includes a first image capturing unit (D1) and a first distance sensor (D2). The first image capturing unit (D1) includes an imager (D11), a lens (D12), and a light source (D13). Referring back to FIG. 1, the first image capturing unit (D1) is adapted to be disposed above one of the photonic integrated circuits (W23) and the lens array (W231) of the one of the photonic integrated circuits (W23) of the integrated circuit component (W2) for capturing an image of the one of the photonic integrated circuits (W23) and/or the lens array (W231) to obtain an orientation of the one of the photonic integrated circuits (W23) and/or the lens array (W231). The first image capturing unit (D1) may be, e.g., a charge coupled device (CCD) camera and the imager (D11) may be, e.g., an image processor. The first distance sensor (D2) may be, e.g., an optical reflective sensor that is adapted to sense a distance between the first distance sensor (D2) and each of a plurality of points on an upper surface of the photonic integrated circuit (W23) to obtain an inclination degree of the upper surface of the photonic integrated circuit (W23).

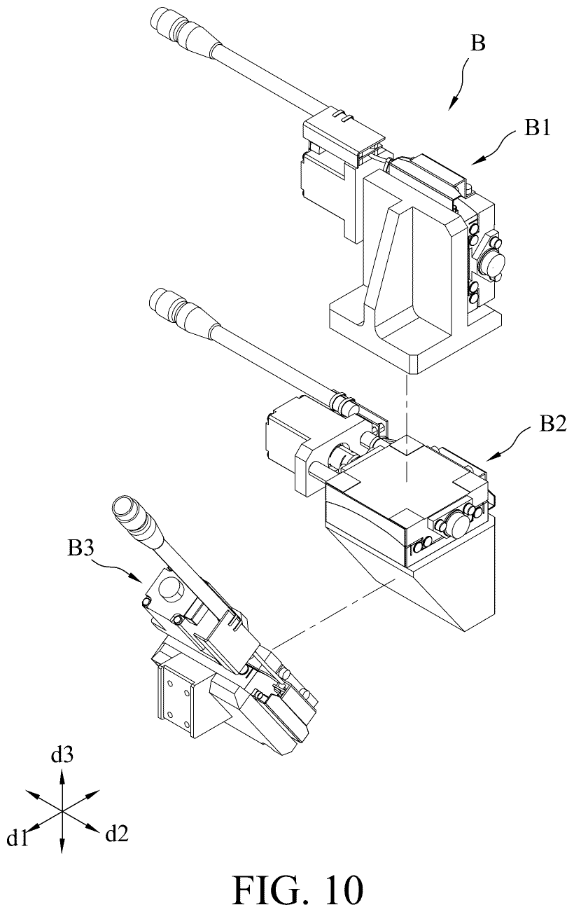

Referring to FIGS. 9 and 10, the second drive mechanism (B) includes a first rotatable assembly (B1) mounted to the third slide seat (A32) of the third straight movement unit (A3) of the first drive mechanism (A), a second rotatable assembly (B2) mounted to the first rotatable assembly (B1), and a third rotatable assembly (B3) mounted to the second rotatable assembly (B2).

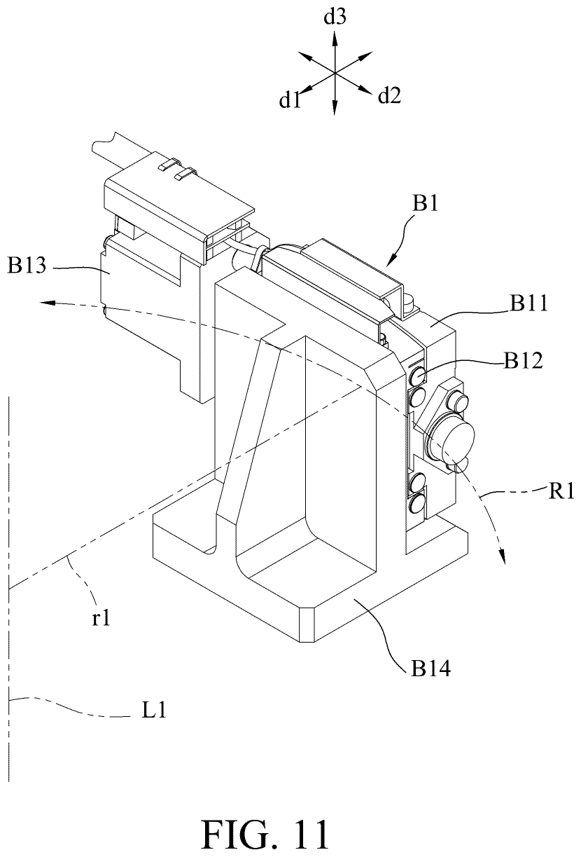

Referring to FIGS. 10 and 11, the first rotatable assembly (B1) is operable to drive the retention mechanism (C) (see FIG. 9) to rotate about a first axis (L1), and includes a first base seat (B11) mounted to the third slide seat (A32) (see FIG. 9), a first movable seat (B12) mounted to the first base seat (B11), a first driver (B13) operable to drive the first movable seat (B12) to move, and a first connecting member (B14) mounted to the first movable seat (B12). The first base seat (B11) is formed with an arcuate concave surface that faces the first movable seat (B12). The first movable seat (B12) is formed with an arcuate convex surface that faces the first base seat (B11) and that is complementary in shape with the arcuate concave surface of the first base seat (B11). The first movable seat (B12) is driven by the first driver (B13) to move arcuately along the first base seat (B11) so that the first connecting member (B14) is driven thereby to move along a first arcuate path (R1) left and right as depicted in FIG. 11. The first movable seat (B12) rotates about the first axis (L1) that is parallel to the third direction (d3). As shown in FIG. 11, a distance between each of a plurality of points on the first arcuate path (R1) and the first axis (L1) is defined as a first radius (r1). In this embodiment, the first base seat (B11) and the first movable seat (B12) are movable relative to each other through a cross bearing, but the present disclosure is not limited hereto.

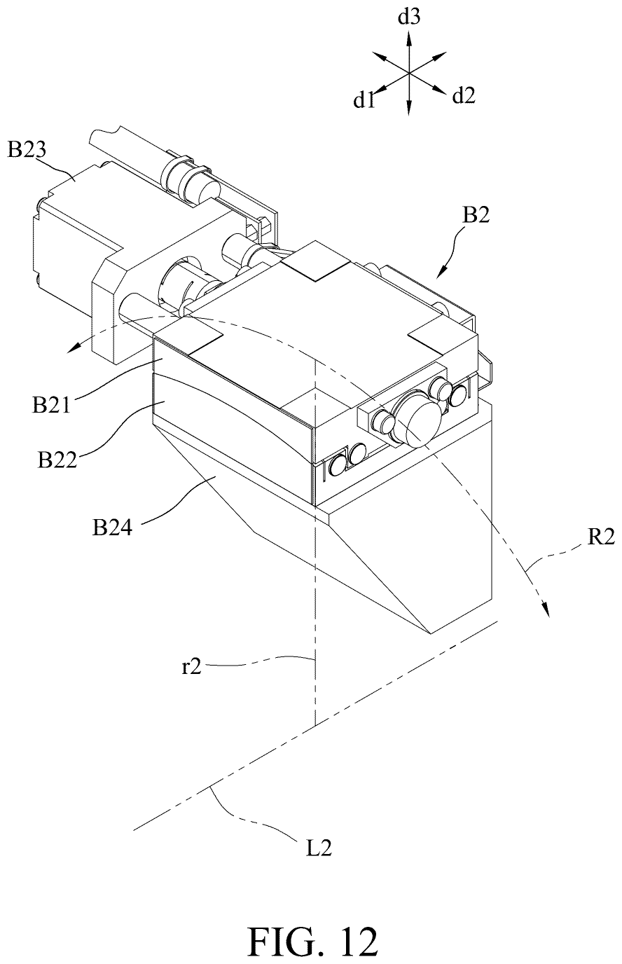

Referring to FIGS. 10 and 12, the second rotatable assembly (B2) is operable to drive the retention mechanism (C) (see FIG. 9) to rotate about a second axis (L2), and includes a second base seat (B21) mounted to the first connecting member (B14) (see FIG. 11), a second movable seat (B22) mounted to the second base seat (B21), a second driver (B23) operable to drive the second movable seat (B22) to move, and a second connecting member (B24) mounted to the second movable seat (B22). The second base seat (B21) is formed with an arcuate concave surface that faces the second movable seat (B22). The second movable seat (B22) is formed with an arcuate convex surface that faces the second base seat (B21) and that is complementary in shape with the arcuate concave surface of the second base seat (B21). The second movable seat (B22) is driven by the second driver (B23) to move arcuately along the second base seat (B21) so that the second connecting member (B24) is driven thereby to move along a second arcuate path (R2) up and down as depicted in FIG. 12. The second movable seat (B22) rotates about the second axis (L2) that is parallel to the first direction (d1). As shown in FIG. 12, a distance between each of a plurality of points on the second arcuate path (R2) and the second axis (L2) is defined as a second radius (r2). In this embodiment, the second base seat (B21) and the second movable seat (B22) are movable relative to each other through a cross bearing, but the present disclosure is not limited hereto.

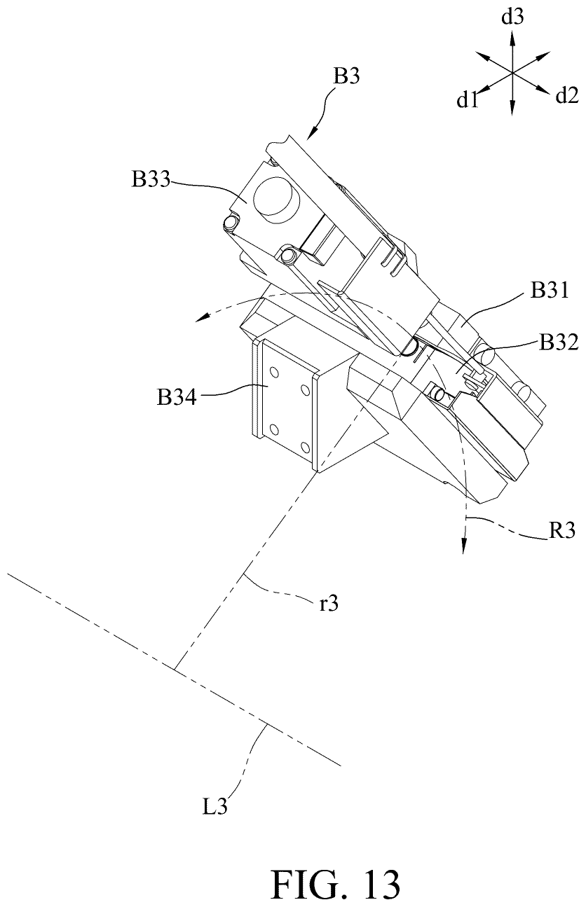

With reference to FIGS. 10 and 13, the third rotatable assembly (B3) is operable to drive the retention mechanism (C) (see FIG. 9) to rotate about a third axis (L3), and includes a third base seat (B31) mounted to the second connecting member (B24) (see FIG. 12), a third movable seat (B32) mounted to the third base seat (B31), a third driver (B33) operable to drive the third movable seat (B32) to move, and a third connecting member (B34) mounted to the third movable seat (B32). The third base seat (B31) is formed with an arcuate concave surface that faces the third movable seat (B32). The third movable seat (B32) is formed with an arcuate convex surface that faces the third base seat (B31) and that is complementary in shape with the arcuate concave surface of the third base seat (B31). The third movable seat (B32) is driven by the third driver (B33) to move arcuately along the third base seat (B31) so that the third connecting member (B34) is driven thereby to move along a third arcuate path (R3) front and rear as depicted in FIG. 13. The third movable seat (B32) rotates about the third axis (L3) that is parallel to the second direction (d2). As shown in FIG. 13, a distance between each of a plurality of points on the third arcuate path (R3) and the third axis (L3) is defined as a third radius (r3). In this embodiment, the third base seat (B31) and the third movable seat (B32) are movable relative to each other through a cross bearing, but the present disclosure is not limited hereto.

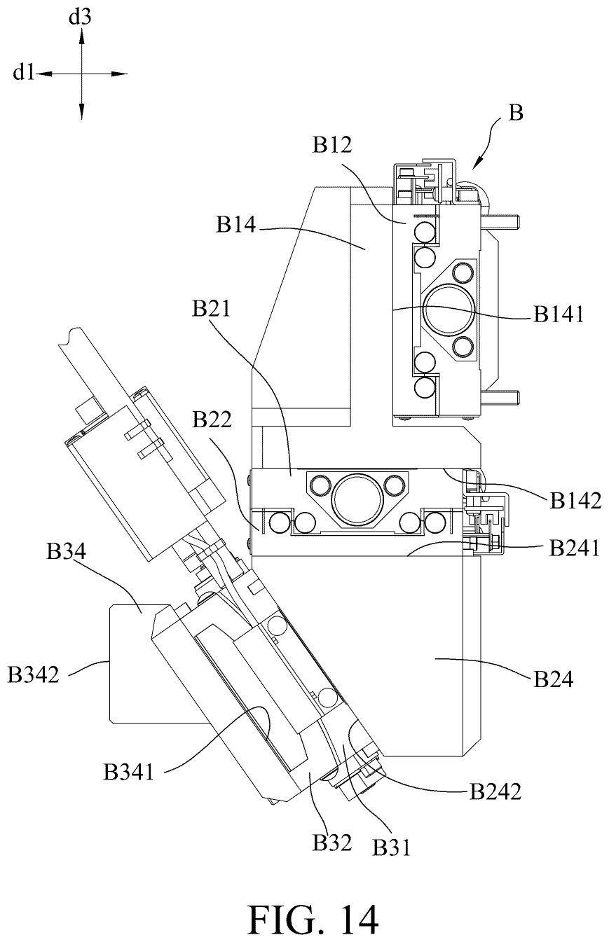

Referring to FIGS. 10 and 14, the first connecting member (B14) has a first connection surface (B141) extending vertically and a second connection surface (B142) extending horizontally. The second connecting member (B24) has a third connection surface (B241) extending horizontally and a fourth connection surface (B242) extending inclinedly. The third connecting member (B34) has a fifth connection surface (B341) extending inclinedly and a sixth connection surface (B342) extending vertically. The first connection surface (B141) is substantially parallel to the sixth connection surface (B342). The fourth connection surface (B242) is substantially parallel to the fifth connection surface (B341). The first connection surface (B141) of the first connecting member (B14) is mounted to the first movable seat (B12) of the first rotatable assembly (B1). The second rotatable assembly (B2) is disposed under the first connecting member (B14) in the third direction (d3). The second base seat (B21) is mounted to the second connection surface (B142) of the first connecting member (B14). The third connection surface (B241) of the second connecting member (B24) is mounted to the second movable seat (B22). The third base seat (B31) of the third rotatable assembly (B3) is mounted to the fourth connection surface (B242) of the second connecting member (B24) that is inclined. The fifth connection surface (B341) of the third connecting member (B34) that is inclined is mounted to the third movable seat (B32). The retention mechanism (C) (see FIG. 9) is mounted to the sixth connection surface (B342).

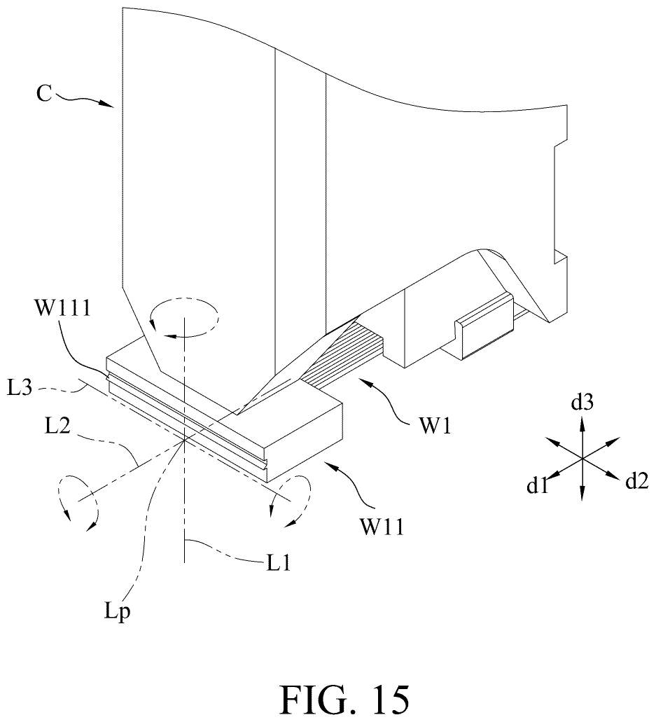

Referring to FIG. 15, the first axis (L1), the second axis (L2), and the third axis (L3) are normal to each other and intersect at an axial point (Lp).

The second drive mechanism (B) is operable to drive the retention mechanism (C) to drive rotations of the fiber array unit (W1) at the axial point (Lp). Specifically, one or more of the first rotatable assembly (B1), the second rotatable assembly (B2), and the third rotatable assembly (B3) drives rotation of the retention mechanism (C) such that the retention mechanism (C) drives the fiber array unit (W1) to rotate about one or more of the first axis (L1), the second axis (L2), and the third axis (L3). The axial point (Lp) is located at a position under the optical coupler (W11) of the fiber array unit (W1) in the third direction (d3) and in front of the prism (W111) of the fiber array unit (W1) in the first direction (d1) when the retention mechanism (C) retains the fiber array unit (W1). As shown in FIG. 5, when the fiber array unit (W1) is coupled to the integrated circuit component (W2), a lower region of the optical coupler (W11) and a front region of the prism (W111) are substantially disposed above an upper surface of the photonic integrated circuit (W23) and correspond in position to the lens array (W231).

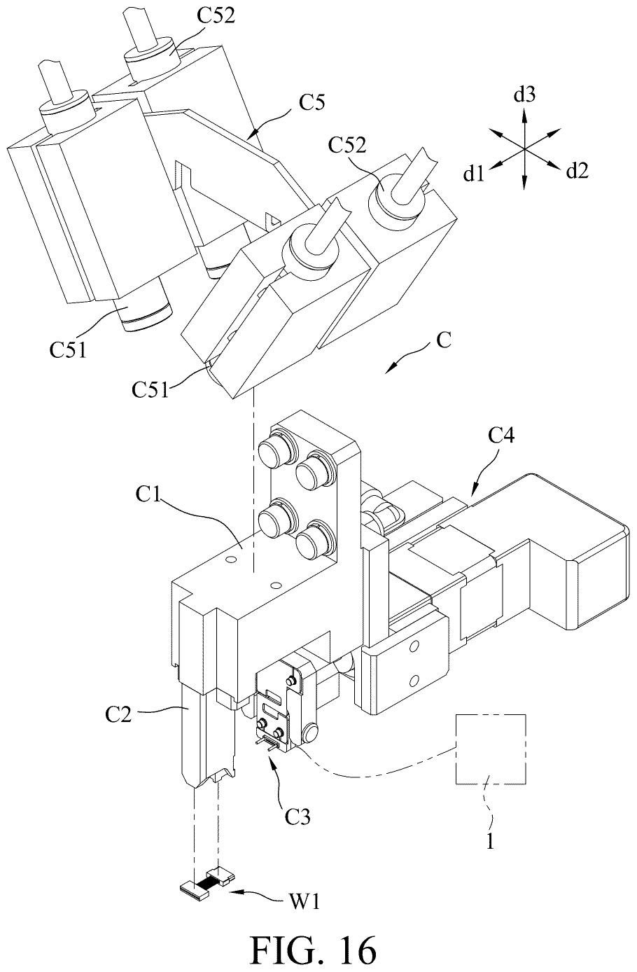

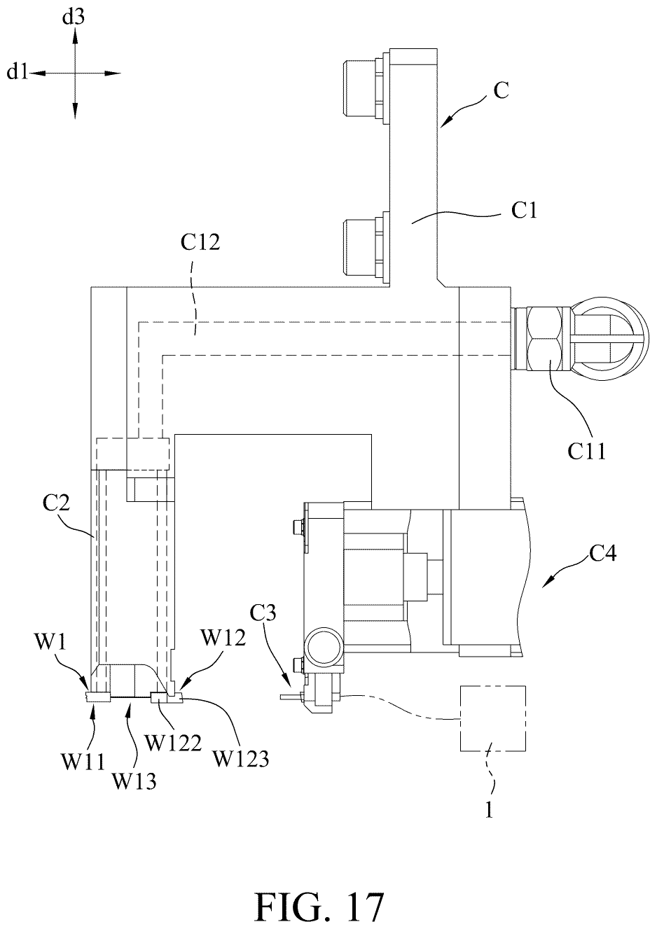

Referring to FIGS. 16 and 17, the retention mechanism (C) includes a support frame (C1), a retention member (C2) mounted to the support frame (C1) and adapted for retaining the fiber array unit (W1), a connector member (C3) mounted to the support frame (C1) and connected to the measurement unit 1, a drive unit (C4) mounted to the support frame (C1) and operable to drive the connector member (C3) to move along the first direction (d1), and a curing unit (C5) disposed on the support frame (C1) and adapted to cure the first adhesive (F1) and the second adhesive (F2). As shown in FIG. 17, the support frame (C1) is formed with an air passage (C12) in fluid communication with a valve (C11). The valve (C11) is in fluid communication with a negative pressure source (not shown). The retention member (C2) and the connector member (C3) are mounted to the support frame (C1) and are co-movable. The connector member (C3) is movable relative to the retention member (C2) in the first direction (d1), and is adapted to be detachably connected to the fiber array unit (W1). In this way, the retention mechanism (C) not only retains the fiber array unit (W1) but is also beneficial for the measurement unit 1 in measuring the intensity of the optical signal (W3) transmitted back to the fiber array unit (W1).

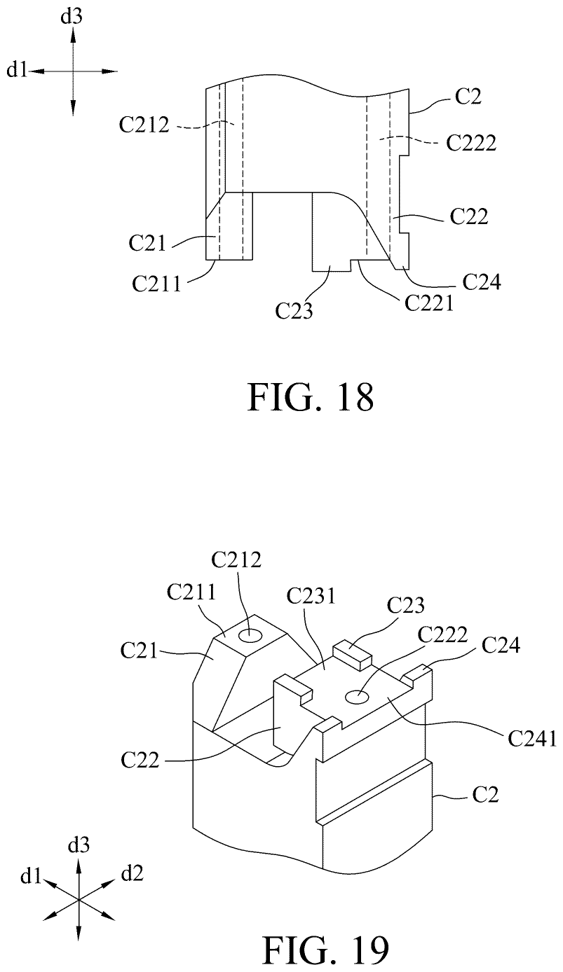

Referring to FIGS. 17 to 19, the retention member (C2) includes a first retention portion (C21) and a second retention portion (C22) spaced apart from the first retention portion (C21) in the first direction (d1). The first retention portion (C21) is adapted for retaining the optical coupler (W11) of the fiber array unit (W1). The second retention portion (C22) is adapted for retaining the receptacle portion (W12) of the fiber array unit (W1). In this way, the retention member (C2) securely retains two opposite ends of the fiber array unit (W1), thereby reducing a possibility that the fiber array unit (W1) falls off from the retention mechanism (C). The first retention portion (C21) has a first retention surface (C211) and a first negative pressure hole (C212) that is formed through the first retention surface (C211) and that is in fluid communication with air passage (C12). The first retention surface (C211) is adapted to be in contact with the optical coupler (W11) of the fiber array unit (W1) for picking up the same through the first negative pressure hole (C212). The second retention portion (C22) has a second retention surface (C221) and a second negative pressure hole (C222) that is formed through the second retention surface (C221) and that is in fluid communication with the air passage (C12). The second retention surface (C221) is adapted to be in contact with the receptacle portion (W12) of the fiber array unit (W1) for picking up the same through the second negative pressure hole (C222). The retention member (C2) has a first limit portion (C23) and a second limit portion (C24). The first limit portion (C23) is disposed on one side of the second retention portion (C22) that is adjacent to the first retention portion (C21). The second limit portion (C24) is disposed on another side of the second retention portion (C22) away from the first retention portion (C21) and has a width in the second direction (d2) greater than a width of the first limit portion (C23) in the second direction (d2). The first limit portion (C23) includes a first accommodating region (C231) adapted for the optical fiber portion (W13) of the fiber array unit (W1) to extend therethrough. The second limit portion (C24) includes a second accommodating region (C241) adapted for the second seat portion (W123) of the receptacle portion (W12) of the fiber array unit (W1) to extend therethrough. When the fiber array unit (W1) is retained by the retention member (C2), the first limit portion (C23) and the second limit portion (C24) are adapted to limit movement of the first seat portion (W122) of the receptacle portion (W12) that has the width in the second direction (d2) larger than the width of the second seat portion (W123) in the second direction (d2). In this way, the first limit portion (C23) and the second limit portion (C24) are adapted to limit movement of the fiber array member (W1) relative to the retention member (C2) in the first direction (d1).

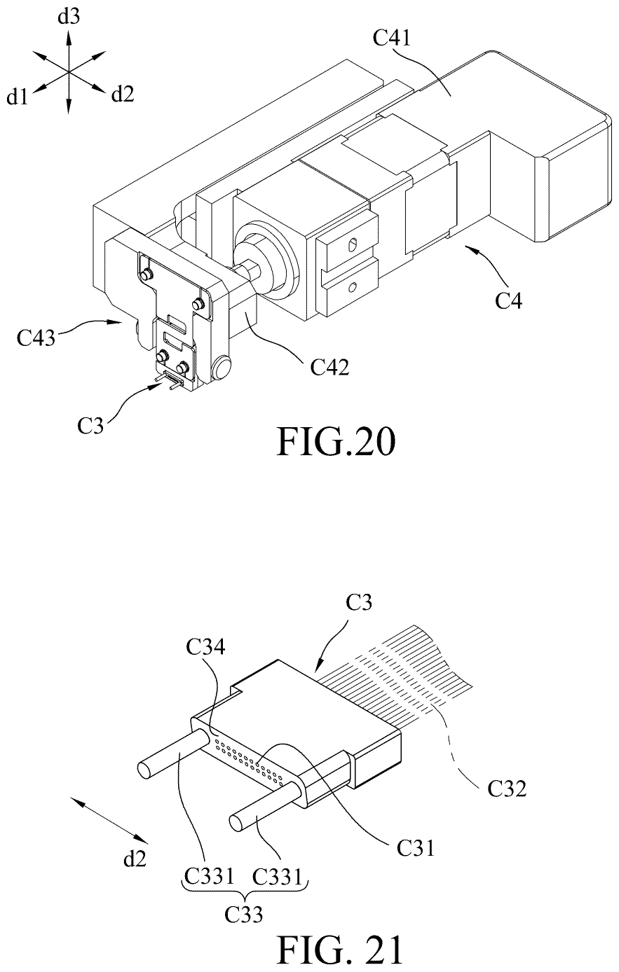

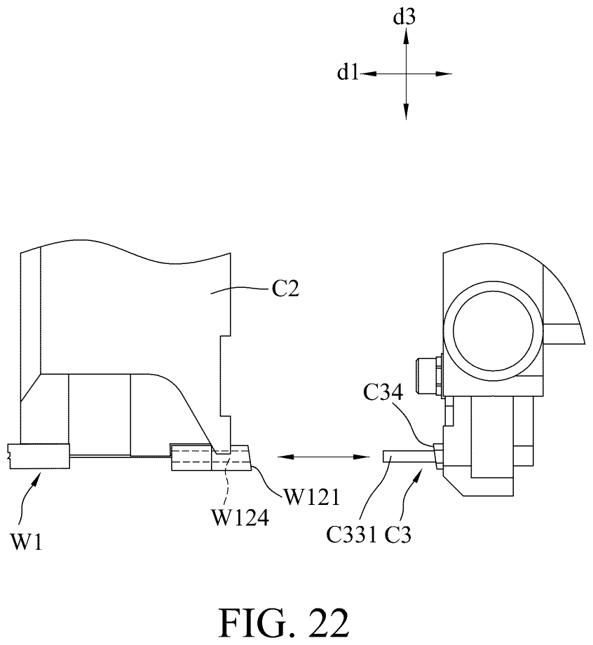

Referring to FIGS. 17 and 20 to 22, the connector member (C3) is mounted to the support frame (C1) via the drive unit (C4). The drive unit (C4) includes a driver member (C41), a movable member (C42) that is driven by the driver member (C41) to move, and a mounting seat (C43) that is mounted to the movable member (C42). The connector member (C3) is mounted to the movable member (C42) through the mounting seat (C43) that is driven by the driver member (C41) to move relative to the retention member (C2) in the first direction (d1), and is adapted to be detachably connected to the fiber array member (W1). The connector member (C3) includes a light passage portion (C31), a light transmission portion (C32) connected between the light passage portion (C31) and the measurement unit 1, and a guiding portion (C33) adapted to be inserted into the fiber array unit (W1). The light passage portion (C31) and the guiding portion (C33) are formed on an abutment surface (C34) of the connector member (C3) that faces the retention member (C2) and that is tilted inwardly from the top to the bottom. An inclination degree of the abutment surface (C34) is the same as an inclination degree of the second side surface (W121) of the receptacle portion (W12) of the fiber array unit (W1). Specifically, the abutment surface (C34) and the second side surface (W121) are parallel to and complementary with each other. As shown in FIG. 21, the guiding portion (C33) includes two guide pins (C331) spaced apart from each other in the second direction (d2) and adapted to be respectively inserted into the two guide holes (W124) of the receptacle portion (W12). When the guide pins (C331) are respectively inserted into the guide holes (W124), the abutment surface (C34) abuts against the second side surface (W121) and the light passage portion (C31) corresponds in position to the optical fiber portion (W13) of the fiber array unit (W1), such that the optical signal (W3) (see FIG. 5) outputted from the measurement unit 1 may be transmitted to the fiber array unit (W1).

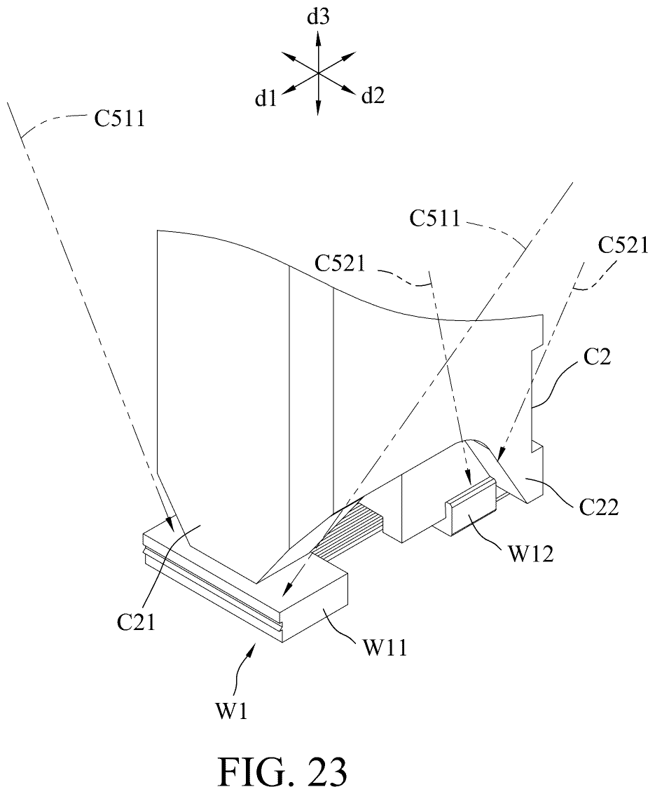

Referring to FIGS. 16, 18 and 23, the curing unit (C5) includes two first light sources (C51) that are spaced apart from each other in the second direction (d2) and two second light sources (C52) that are respectively spaced apart from the first light sources (C51) in the first direction (d1). The first light sources (C51) are operable to emit ultraviolet light (C511) toward the first retention portion (C21) of the retention member (C2). The second light sources (C52) are operable to emit laser light (C521) toward the second retention portion (C22) of the retention member (C2). It should be noted that the numbers of the first light sources (C51) and the second light sources (C52) are not limited in this embodiment.

Referring to FIG. 7, the first stage device 4 and the second stage device 5 are spaced apart from each other in the second direction (d2), are parallel to each other, and are located within a range in which the component coupling device 2 is movable. The first stage device 4 includes a first stage 41 adapted to carry the integrated circuit component (W2), a first rotatable seat 42 operable to drive the first stage 41 to rotate horizontally, and a first stage rail seat 43 operable to drive the first rotatable seat 42 and the first stage 41 to move in the first direction (d1). The second stage device 5 includes a second stage 51 adapted to carry the fiber array unit (W1), and a second stage rail seat 52 operable to drive the second stage 51 to move in the first direction (d1). In this embodiment, the retention mechanism (C) is operable to move sequentially among the second stage 51, the adhesive coating device 10, and the first stage 41.

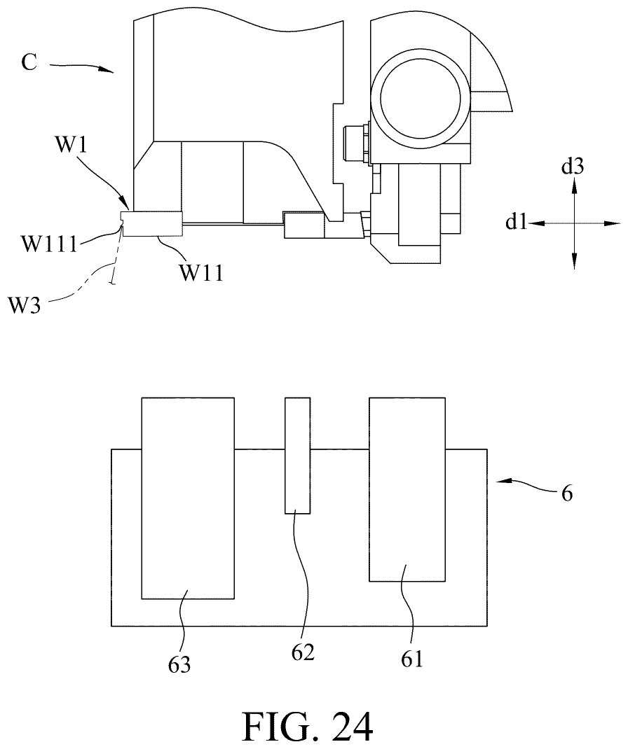

Referring to FIGS. 7 and 24, the detection device 6 is adapted to be disposed on the machine bed (T), is disposed between the first stage device 4 and the second stage device 5, and is disposed within a range in which the component coupling device 2 is movable. The detection device 6 is adapted for detection of the fiber array unit (W1). The detection device 6 includes a second image capturing unit 61, a second distance sensor 62, and an optical integrator 63. The second image capturing unit 61 is adapted to be disposed under the optical coupler (W11) and/or the prism (W111) of the fiber array unit (W1) for capturing an image of the optical coupler (W11) and/or the prism (W111) to obtain an orientation of the optical coupler (W11) and/or the prism (W111). The second distance sensor 62 is adapted to sense a distance between the second distance sensor 62 and each of a plurality of points on a lower surface of the optical coupler (W11) to obtain an inclination degree of the lower surface of the optical coupler (W11). The second image capturing unit 61 and the second distance sensor 62 may have the same structures as the first image capturing unit (D1) (see FIG. 9) and the first distance sensor (D2) (see FIG. 9), respectively. The optical integrator 63 is adapted to be disposed under the fiber array unit (W1) retained by the retention mechanism (C) for measuring an intensity of the optical signal (W3). The optical integrator 63 may be, for example, an integrating sphere. Specifically, the optical integrator 63 measures the intensity of the optical signal (W3) outputted from the fiber array unit (W1). The measurement unit 1 (see FIG. 17) is configured to measure the intensity of the optical signal (W3) transmitted from the measurement unit 1 through the fiber array unit (W1) to the integrated circuit component (W2) (see FIG. 5) and then transmitted back to the fiber array unit (W1).

Referring to FIG. 7, the first track device 7 and the second track device 8 are adapted to be disposed on the machine bed (T) and are spaced apart from each other in the second direction (d2). The first track device 7 includes a first track 71 adapted for conveying a first boat (S1) in the first direction (d1). The first boat (S1) carries the integrated circuit component (W2). The first track 71 may be, for example, an assembly of a rail and a conveyor belt. The second track device 8 includes a second track 81 adapted for conveying a second boat (S2) in the first direction (d1). The second boat (S2) carries the fiber array unit (W1). The second track 81 is, for example, an assembly of a rail and a conveyor belt. The component transfer device 9 is adapted to be disposed on the machine bed (T) and includes a gantry 91 disposed across the first track device 7 and the second track device 8, a first placement mechanism 92 mounted to the gantry 91, and a second placement mechanism 93 mounted to the gantry 91. The first placement mechanism 92 and the second placement mechanism 93 are movable along the gantry 91 in the second direction (d2). Specifically, the first placement mechanism 92 is movable between the first boat (S1) and the first stage 41, and the second placement mechanism 93 is movable between the second boat (S2) and the second stage 51. The first placement mechanism 92 and the second placement mechanism 93 may be, for example, a suction cup or a suction nozzle.

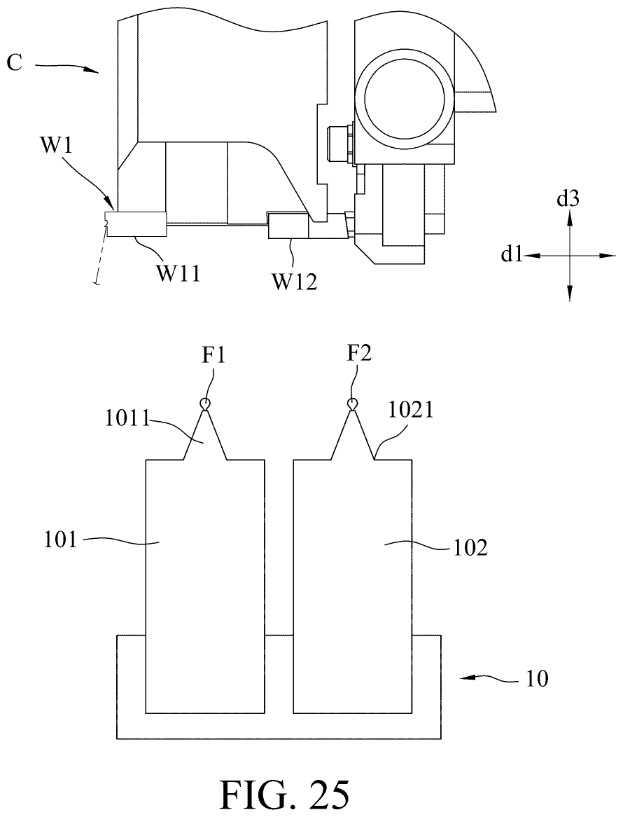

Referring to FIGS. 7 and 25, the adhesive coating device 10 is disposed on one side of the second stage device 5 away from the detection device 6, and is disposed within a range in which the component coupling device 2 is movable. The adhesive coating device 10 includes a first adhesive valve 101 adapted for coating the first adhesive (F1) onto the fiber array unit (W1) and a second adhesive valve 102 adapted for coating the second adhesive (F2) onto the fiber array unit (W1). The retention mechanism (C) is movable relative to the first adhesive valve 101 and the second adhesive valve 102. The first adhesive valve 101 includes a first adhesive nozzle 1011 facing upward and adapted for discharging the first adhesive (F1). The second adhesive valve 102 includes a second adhesive nozzle 1021 facing upward and adapted for discharging the second adhesive (F2). In this embodiment, the first adhesive valve 101 and the second adhesive valve 102 are, for example, a syringe pump, but the present disclosure is not limited thereto. In other embodiments, the first adhesive valve 101 and the second adhesive valve 102 may be screw valves, piezoelectric valves, aerosol valves, etc.

The first boat (S1) carries one integrated circuit component (W2) in the embodiment of the present disclosure, and may carry more than one integrated circuit components (W2) in other embodiments. The first boat (S1) is fed onto the first track 71 from one end of the first track device 7. The second boat (S2) carries a plurality of fiber array units (W1) in this embodiment, and may carry only one fiber array unit (W1) in other embodiments. The second boat (S2) is fed onto the second track 81 from one end of the second track device 8. The first boat (S1) and the second boat (S2) are respectively conveyed along the first track 71 and the second track 81 to a position under the gantry 91.

Next, the first stage 41 and the second stage 51 are driven respectively by the first stage rail seat 43 and the second stage rail seat 52 to move to the position under the gantry 91. The first placement mechanism 92 of the component transfer device 9 is controlled by the control unit 3 to pick up the integrated circuit component (W2) carried on the first boat (S1) and place the same on the first stage 41. The second placement mechanism 93 is controlled by the control unit 3 to pick up the fiber array unit (W1) carried on the second boat (S2) and place the same on the second stage 51. After the integrated circuit component (W2) and the fiber array unit (W1) are respectively disposed on the first stage 41 and the second stage 51, the first stage 41 and the second stage 51 are driven respectively by the first stage rail seat 43 and the second stage rail seat 52 to move to a position under the second straight movement unit (A2) of the first drive mechanism (A).

The first drive mechanism (A) is controlled to drive the inspection mechanism (D) to move horizontally to be disposed above the first stage 41 to obtain the orientation of one of the photonic integrated circuits (W23) and/or the lens array (W231) of the one of the photonic integrated circuits (W23), and the inclination degree of the upper surface of the one of the photonic integrated circuits (W23). The control unit 3 is electrically connected to the inspection mechanism (D) and is configured to store the orientation of the one of the photonic integrated circuits (W23) and/or the lens array (W231) and the inclination degree of the upper surface of the one of the photonic integrated circuits (W23) upon receipt of the same. For example, the measurement unit 1 may be a passive optical component testing platform including a tunable laser module, a switch, a polarizer, and a test instrument for testing Wavelength Division Multiplexing (WDM) devices and photonic integrated circuits. It should be noted that, in this embodiment, each of the measurement unit 1 and the control unit 3 includes a microcontroller or a controller such as, but not limited to, a single core processor, a multi-core processor, a dual-core mobile processor, a microprocessor, a digital signal processor (DSP), a field-programmable gate array (FPGA), an application specific integrated circuit (ASIC), a radio-frequency integrated circuit (RFIC), etc. In addition, each of the measurement unit 1 and the control unit 3 may be embodied in: executable software as a set of logic instructions stored in a machine-or computer-readable storage medium of a memory such as random access memory (RAM), read only memory (ROM), programmable ROM (PROM), firmware, flash memory, etc.; configurable logic such as programmable logic arrays (PLAs), field programmable gate arrays (FPGAs), complex programmable logic devices (CPLDs), etc.; fixed-functionality logic hardware using circuit technology such as application specific integrated circuit (ASIC), complementary metal oxide semiconductor (CMOS), transistor-transistor logic (TTL) technology, etc.; or any combination thereof.

After the orientation of the one of the photonic integrated circuits (W23) and/or the lens array (W231) and the inclination degree of the upper surface of the one of the photonic integrated circuits (W23) are obtained, the second drive mechanism (B) is driven by the first drive mechanism (A) to drive the retention mechanism (C) to move horizontally in the second direction (d2) to be disposed above the second stage 51. Then, when the second drive mechanism (B) is driven by the first drive mechanism (A) to drive the retention mechanism (C) to move downwardly in the third direction (d3), the retention member (C2) comes into contact with the fiber array unit (W1) carried on the second stage 51. At the same time, the negative pressure source connected to the valve (C11) is turned on such that the first retention portion (C21) and the second retention portion (C22) of the retention member (C2) respectively suck the optical coupler (W11) and the receptacle portion (W12) of the fiber array unit (W1) to pick up the fiber array unit (W1). Subsequently, the drive assembly (C4) drives the connector member (C3) to move toward the fiber array unit (W1) to be coupled to the fiber array unit (W1), so the optical signal (W3) outputted from the measurement unit 1 may be transmitted to the fiber array unit (W1).

After the connector member (C3) is connected to the fiber array unit (W1), the first drive mechanism (A) is controlled to drive the second drive mechanism (B) to drive the retention mechanism (C) to move upwards, such that the fiber array unit (W1) that is picked up and retained by the retention member (C2) is moved away from the second stage 51. Then, the first drive mechanism (A) is controlled to drive the second drive mechanism (B) to move horizontally in the second direction (d2) toward the detection device 6, so that the detection device 6 may obtain an orientation of the optical coupler (W11) and/or the prism (W111) of the fiber array unit (W1), obtain an inclination degree of the lower surface of the optical coupler (W11), and measure the intensity of the optical signal (W3). The control unit 3 is electrically connected to the detection device 6 and stores the orientation of the optical coupler (W11) and/or the prism (W111), the inclination degree of the lower surface of the optical coupler (W11), and the intensity of the optical signal (W3) upon receipt of the same. The control unit 3 is configured to compare the orientation of the optical coupler (W11) and/or the prism (W111) to the orientation of the one of the photonic integrated circuits (W23) and/or the lens array (W231) to obtain an orientation deviation, and to control, according to the orientation deviation, the first rotatable assembly (B1) of the second drive mechanism (B) to rotate about the first axis (L1) along the first arcuate path (R1) left and right as depicted in FIGS. 11 and 15. In this way, a posture of the fiber array unit (W1) retained by the retention mechanism (C) is adjusted such that the orientation of the optical coupler (W11) and/or the prism (W111) is registered with the orientation of the one of the photonic integrated circuits (W23) and/or the lens array (W231).

Similarly, the control unit 3 is configured to compare the inclination degree of the lower surface of the optical coupler (W11) and the inclination degree of the one of the photonic integrated circuits (W23) to obtain an inclination deviation, and to control, according to the inclination deviation, the second rotatable assembly (B2) of the second drive mechanism (B) to rotate about the second axis (L2) along the second arcuate path (R2) up and down as depicted in FIGS. 12 and 15 and the third rotatable assembly (B3) to rotate about the third axis (L3) along the third arcuate path (R3) front and rear as depicted in FIGS. 13 and 15. In this way, the posture of the fiber array unit (W1) retained by the retention mechanism (C) is adjusted such that the lower surface of the optical coupler (W1) is parallel to the upper surface of the one of the photonic integrated circuits (W23).

Additionally, the intensity of the optical signal (W3) is provided for correction of the posture of the fiber array element (W1). Generally, optical loss may occur when the optical signal (W3) is transmitted. For example, an intensity of the optical signal (W3) directly outputted from the measurement unit 1 is 100 units, whereas the intensity of the optical signal (W3) outputted from the fiber array unit (W1) and measured by the optical integrator 63 is 90 units. The control unit 3 stores 90 units as the intensity of the optical signal (W3) and is configured to control the first drive mechanism (A) and the second drive mechanism (B) to adjust the posture (orientation or inclination degree) of the fiber array element (W1) accordingly.

After the second drive mechanism (B) drives the retention mechanism (C) to adjust the posture of the fiber array unit (W1), the first drive mechanism (A) drives the second drive mechanism (B) to move the retention mechanism (C) horizontally toward the adhesive coating device 10 for coating adhesive. The retention mechanism (C) retains the fiber array unit (W1) to move relative to the first adhesive valve 101 and the second adhesive valve 102 in the second direction (d2). Then, the first adhesive valve 101 and the second adhesive valve 102 respectively discharge the first adhesive (F1) and the second adhesive (F2) onto the lower surface of the optical coupler (W11) and a lower surface of the receptacle portion (W12).

After the first adhesive (F1) and the second adhesive (F2) are coated onto the fiber array unit (W1), the first drive mechanism (A) drives the second drive mechanism (B) to move the retention mechanism (C) horizontally to a position above the first stage 41. Since the retention mechanism (C) is driven by the second drive mechanism (B) to adjust orientation of the optical coupler (W11) and/or the prism (W111) to be registered with the orientation of the one of the photonic integrated circuits (W23), and the lower surface of the optical coupler (W11) is parallel to the upper surface of the one of the photonic integrated circuits (W23), after the retention mechanism (C) is moved to the position above the first stage 41, the first drive mechanism (A) directly drives the second drive mechanism (B) to move together with the retention mechanism (C) downwardly in the third direction (d3), so the lower surface of the optical coupler (W11) and the lower surface of the receptacle portion (W12) are respectively in contact with the upper surface of the one of the photonic integrated circuits (W23) and an upper surface of the second lid portion (W222) of the lid unit (W22) respectively via the first adhesive (F1) and the second adhesive (F2). In this way, the optical signal (W3) may be transmitted between the fiber array unit (W1) and the integrated circuit component (W2) via the prism (W111) and the lens array (W231). At this time, the fiber array unit (W1) is still retained by the retention member (C2) of the retention mechanism (C).

After the fiber array unit (W1) is disposed on the integrated circuit component (W2), because the first adhesive (F1) and the second adhesive (F2) are not cured yet, each of the first adhesive (F1) and the second adhesive (F2) has a certain height in the third direction (d3), and the fiber array unit (W1) floats on the first adhesive (F1) and the second adhesive (F2) and may be adjusted by the retention mechanism (C). At this time, the measurement unit 1 measures the intensity of the optical signal (W3) to determine whether the intensity of the optical signal (W3) falls within a predetermined range. When the intensity of the optical signal (W3) does not fall within the predetermined range, the control unit 3 controls the second drive mechanism (B) to drive rotations of the fiber array unit (W1) with the axial point (Lp) serving as a rotational center, where the fiber array unit (W1) is rotatable about one or more of the first axis (L1), the second axis (L2), the third axis (L3) with three degrees of freedom. Thus, the posture of the fiber array unit (W1) may be slightly adjusted when being disposed on the integrated circuit component (W2) until the intensity of the optical signal (W3) measured by the measurement unit 1 falls within the predetermined range. At this time, the second drive mechanism (B) is controlled by the control unit 3 to stop moving. When it is determined that the intensity of the optical signal (W3) falls within the predetermined range, the optical signal (W3) transmitted between the fiber array unit (W1) and the integrated circuit component (W2) has a relatively good transmission performance. It should be noted that the predetermined range is in positive correlation with the intensity of the optical signal (W3) that has been stored in the control unit 3 and that is measured by the detection device 6. For example, in a case where the intensity of the optical signal (W3) that has been stored is 90 units, since there is optical loss when the optical signal (W3) is transmitted between the fiber array unit (W1) and the integrated circuit component (W2), the predetermined range may be preset between 80 units and 90 units. When the intensity of the optical signal (W3) measured by the measurement unit 1 is 75 units, the control unit 3 controls the second drive mechanism (B) to continuously drive the retention mechanism (C) to adjust the posture of the fiber array unit (W1) until the intensity of the optical signal (W3) measured by the measurement unit 1 is within the range of 80 units to 90 units.

It should be noted that the order of operations of the first rotatable assembly (B1), the second rotatable assembly (B2), and the third rotatable assembly (B3) of the second drive mechanism (B) is prioritized by the third rotatable assembly (B3), followed by the second rotatable assembly (B2) and then the first rotatable assembly (B1). When the intensity of the optical signal (W3) measured by the measurement unit 1 falls within the predetermined range after the third rotatable assembly (B3) drives the retention mechanism (C) to rotate the fiber array unit (W1) about the third axis (L3), the first rotatable assembly (B1) and the second rotatable assembly (B2) are not required to be driven. When the intensity of the optical signal (W3) still does not fall within the predetermined range after the second drive mechanism (B) drives the retention mechanism (C) to slightly adjust the posture of the fiber array unit (W1), the first drive mechanism (A) is controlled by the control unit 3 to drive the second drive mechanism (B) together with the retention mechanism (C) to move the fiber array unit (W1) linearly in one or more of the first direction (d1), the second direction (d2), and the third direction (d3) with three degrees of freedom. Then, the second drive mechanism (B) is controlled to drive the retention mechanism (C) to drive rotations of the fiber array unit (W1) about one or more of the first axis (L1), the second axis (L2), and the third axis (L3) with three degrees of freedom to adjust the posture of the fiber array unit (W1). That is to say, the fiber array unit (W1) may be adjusted to a relatively large extent when being disposed on the integrated circuit component (W2) until the intensity of the optical signal (W3) measured by the measurement unit 1 falls within the predetermined range. Then, the first drive mechanism (A) and the second drive mechanism (B) are controlled to stop movement and rotation.

When the intensity of the optical signal (W3) falls within the predetermined range, the curing unit (C5) cures the first adhesive (F1) and the second adhesive (F2) respectively by the ultraviolet light (C511) and the laser light (C521). It should be noted that since the optical coupler (W11) is made of a light-transmissive material, the ultraviolet light (C511) may propagate through the optical coupler (W11) and cure the first adhesive (F1) disposed between the optical coupler (W11) and the photonic integrated circuit (W23). In addition, since the laser light (C521) is capable of generating heat, the second adhesive (F2) disposed between the receptacle portion (W12) and the second lid portion (W222) of the lid unit (W22) may be heated to be cured. After the first adhesive (F1) and the second adhesive (F2) are cured, the drive unit (C4) drives the connector member (C3) to move away from the fiber array unit (W1) to be detached from the fiber array unit (W1). After the connector member (C3) is detached from the fiber array unit (W1), the negative pressure source is turned off and the retention member (C2) is moved away from the fiber array unit (W1) to complete the process of coupling the fiber array unit (W1) to the integrated circuit component (W2).

It should be noted that a predetermined number of the fiber array units (W1) may be sequentially coupled to the integrated circuit component (W2) by the first drive mechanism (A) and the second drive mechanism (B) of the component coupling device 2 that are driven to drive movement and rotation of the retention mechanism (C) as described in the abovementioned operations. In a case where four of the photonic integrated circuits (W23) are respectively disposed adjacent to the four sides of the carrier board (W21), the two component coupling devices 2 may perform component coupling operation of two of the fiber array units (W1) respectively to two of the photonic integrated circuits (W23) of the integrated circuit component (W2) that are disposed adjacent to two of the sides of the carrier board (W21). After the component coupling operation at the two of the sides is completed, the first rotatable seat 42 drives the first stage 41 to rotate for 90 degrees, then the two component coupling devices 2 may perform the component coupling operation adjacent to another two of the sides of the carrier board (W21). After the predetermined number of the fiber array units (W1) are coupled to the integrated circuit component (W2), the first stage 41 is driven by the first stage rail seat 43 to move back to the position under the gantry 91, and the first placement mechanism 92 picks up the integrated circuit component (W2) on which the component coupling operation is performed and places the same on the first boat (S1). Subsequently, the first boat (S1) is conveyed outwardly from the first track 7 from another end of the first track device 7. After the fiber array units (W1) disposed on the second boat (S2) have run out, the second boat (S2) is conveyed outwardly from the second track 81 from another end of the second track device 8.

In the embodiment of the component coupling apparatus 11 according to the present disclosure, the fiber array unit (W1) is retained by the retention mechanism (C) and is driven by the retention mechanism (C) to move toward the adhesive coating device 10. Then, the adhesive coating device 10 discharges the first adhesive (F1) and the second adhesive (F2) respectively onto the optical coupler (W11) and the receptacle portion (W12) of the fiber array unit (W1). As compared to the prior art, installing a mechanism for moving an adhesive valve toward the integrated circuit component (W2) is not required. Furthermore, by virtue of the detection device 6 and the inspection mechanism (D) that respectively detect and inspect the fiber array unit (W1) and the integrated circuit component (W2), the fiber array unit (W1) is registered with the integrated circuit component (W2) such that the first adhesive (F1) and the second adhesive (F2) may be accurately disposed between the fiber array unit (W1) and the integrated circuit component (W2). Thus, the fiber array unit (W1) may be securely coupled to the integrated circuit component (W2) and a yield rate of the component coupling apparatus 11 is relatively good.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to lid various arrangements included within the spirit and scope of the broadest interpretation so as to encompass all such modifications and equivalent arrangements.

What is claimed is:

1. A component coupling apparatus adapted to be disposed on a machine bed and comprising:
a first stage device that includes a first stage adapted to carry an integrated circuit component;
a second stage device that includes a second stage adapted to carry an fiber array unit;
an adhesive coating device that includes a first adhesive valve adapted for coating a first adhesive onto the fiber array unit; and
at least one component coupling device that includes a retention mechanism adapted to retain the fiber array unit, said retention mechanism being operable to drive the fiber array unit to move sequentially among said second stage, said adhesive coating device, and said first stage.

2. The component coupling apparatus as claimed in claim 1, wherein:
said first stage device and said second stage device are spaced apart from each other and are parallel to each other;
said first stage device further includes a first stage rail seat operable to drive said first stage to move; and
said second stage device further includes a second stage rail seat operable to drive said second stage to move.

3. The component coupling apparatus as claimed in claim 2, wherein:
said first stage device further includes a first rotatable seat operable to drive said first stage to rotate; and
said first stage rail seat drives said first rotatable seat and said first stage to move.

4. The component coupling apparatus as claimed in claim 2, wherein:
said component coupling apparatus further comprises a first track device and a second track device that are adapted to be disposed on the machine bed, that are spaced apart from each other, and that are arranged in parallel;
said first track device includes a first track adapted for conveying a first boat;
said second track device includes a second track adapted for conveying a second boat;
the integrated circuit component is carried on the first boat; and
the fiber array unit is carried on the second boat.

5. The component coupling apparatus as claimed in claim 4, wherein:
said component coupling apparatus further comprises a component transfer device adapted to be disposed on the machine bed;
said component transfer device includes
a gantry disposed across said first track device and said second track device,
a first placement mechanism mounted to said gantry and movable along said gantry to move between the first boat and said first stage, and
a second placement mechanism mounted to said gantry and movable along said gantry to move between the second boat and said second stage.

6. The component coupling apparatus as claimed in claim 1, wherein said at least one component coupling device includes two component coupling devices that are adapted to be disposed on the machine bed and that are disposed to face each other.

7. The component coupling apparatus as claimed in claim 1, wherein:
said adhesive coating device further includes a second adhesive valve adapted for coating a second adhesive onto the fiber array unit;
said first adhesive valve includes a first adhesive nozzle facing upward and adapted for discharging the first adhesive;
said second adhesive valve includes a second adhesive nozzle facing upward and adapted for discharging the second adhesive;
said retention mechanism is adapted to retain the fiber array unit and is movable relative to said first adhesive valve and said second adhesive valve;
said first adhesive valve is adapted for coating the first adhesive onto a lower surface of an optical coupler of the fiber array unit; and
said second adhesive valve is adapted for coating the second adhesive onto a lower surface of a receptacle portion of the fiber array unit.

8. The component coupling apparatus as claimed in claim 1, wherein:
said at least one component coupling device further includes an inspection mechanism adapted for inspection of the integrated circuit component;
said inspection mechanism includes a first image capturing unit and a first distance sensor;
said first image capturing unit is adapted to be disposed above one of a photonic integrated circuit, a lens array of the integrated circuit component and a combination thereof for capturing an image of one of the photonic integrated circuit, the lens array and the combination thereof to obtain an orientation of one of the photonic integrated circuit and the lens array;
said first distance sensor is adapted to sense a distance between said first distance sensor and each of a plurality of points on an upper surface of the photonic integrated circuit to obtain an inclination degree of the upper surface of the photonic integrated circuit.

9. The component coupling apparatus as claimed in claim 1, wherein:
said component coupling apparatus further comprises a detection device adapted to be disposed on the machine bed and adapted for detection of the fiber array unit,
said detection device includes a second image capturing unit and a second distance sensor,
said second image capturing unit is adapted to be disposed under one of an optical coupler, a prism of the fiber array unit and a combination thereof retained by said retention mechanism for capturing an image of one of the optical coupler, the prism and the combination thereof to obtain an orientation of one of the optical coupler, the prism and the combination thereof;
said second distance sensor is adapted to sense a distance between said second distance sensor and each of a plurality of points on a lower surface of the optical coupler to obtain an inclination degree of the lower surface of the optical coupler.

10. The component coupling apparatus as claimed in claim 9, wherein:
said detection device further includes an optical integrator; and
said optical integrator is adapted to be disposed under the fiber array unit retained by said retention mechanism for measuring an intensity of an optical signal outputted from the fiber array unit.

11. The component coupling apparatus as claimed in claim 1, wherein
said at least one component coupling device further includes
a first drive mechanism disposed on the machine bed, and
a second drive mechanism disposed on said first drive mechanism and driven by said first drive mechanism to move linearly in a plurality of directions; and
said retention mechanism is disposed on said second drive mechanism and is driven by said second drive mechanism to rotate about a plurality of axes.

12. The component coupling apparatus as claimed in claim 11, wherein:
said first drive mechanism includes
a first straight movement unit adapted to be disposed on the machine bed and operable to drive said second drive mechanism to move linearly in a first direction,
a second straight movement unit mounted to said first straight movement unit and operable to drive said second drive mechanism to move linearly in a second direction, and
a third straight movement unit mounted to said second straight movement unit and operable to drive said second drive mechanism to move linearly in a third direction;
one of said first straight movement unit, said second straight movement unit, said third straight movement unit, and a combination thereof drives said second drive mechanism to move linearly such that said retention mechanism drives movement of the fiber array unit;
the first direction, the second direction and the third direction are normal to each other; and
the first direction and the second direction are horizontal directions and the third direction is a vertical direction.

13. The component coupling apparatus as claimed in claim 11, wherein:
said second drive mechanism includes
a first rotatable assembly mounted to said first drive mechanism and operable to drive said retention mechanism to rotate about a first axis,
a second rotatable assembly mounted to said first rotatable assembly and operable to drive said retention mechanism to rotate about a second axis, and
a third rotatable assembly mounted to said second rotatable assembly and operable to drive said retention mechanism to rotate about a third axis;
one of said first rotatable assembly, said second rotatable assembly, said third rotatable assembly, and a combination thereof drives rotation of said retention mechanism such that said retention mechanism drives rotation of the fiber array unit;
the first axis is parallel to a third direction, the second axis is parallel to a first direction, and the third axis is parallel to a second direction;
the first direction, the second direction, and the third direction are normal to each other; and
the first direction and the second direction are horizontal directions and the third direction is a vertical direction.

14. The component coupling apparatus as claimed in claim 13, wherein:
the first axis, the second axis, and the third axis intersect at an axial point; and
said second drive mechanism is operable to drive said retention mechanism to drive rotations of the fiber array unit with the axial point serving as a rotational center.

15. The component coupling apparatus as claimed in claim 1, wherein:
said component coupling apparatus further comprises a measurement unit adapted to be disposed on the machine bed;
said retention mechanism includes a retention member adapted for retaining the fiber array unit and a connector member connected to said measurement unit; and
said connector member is movable relative to said retention member and adapted to be detachably connected to the fiber array unit.

16. The component coupling apparatus as claimed in claim 15, wherein:
said retention mechanism further includes a drive unit operable to drive said connector member to move;
said drive unit includes a driver member and a movable member;
said connector member is mounted to said movable member that is driven by said driver member to move relative to said retention member and is adapted to be detachably connected to the fiber array unit.

17. The component coupling apparatus as claimed in claim 1, wherein:
said retention mechanism includes a retention member adapted for retaining the fiber array unit;
said retention member includes a first retention portion and a second retention portion that are spaced apart from each other;
said first retention portion is adapted for retaining an optical coupler of the fiber array unit;
said second retention portion is adapted for retaining a receptacle portion of the fiber array unit;
said first retention portion has a first retention surface, and a first negative pressure hole that is formed through said first retention surface;
said first retention surface is adapted to be in contact with the optical coupler of the fiber array unit for picking up the optical coupler through said first negative pressure hole;
said second retention portion has a second retention surface, and a second negative pressure hole that is formed through said second retention surface; and
said second retention surface is adapted to be in contact with the receptacle portion of the fiber array unit for picking up the receptacle portion through said second negative pressure hole.

18. The component coupling apparatus as claimed in claim 17, wherein:
said retention member further includes a first limit portion and a second limit portion;
said first limit portion is disposed on one side of said second retention portion adjacent to said first retention portion;
said second limit portion is disposed on another side of said second retention portion away from said first retention portion; and
said first limit portion and said second limit portion are adapted to limit movement of the fiber array unit.

19. The component coupling apparatus as claimed in claim 18, wherein:
said first limit portion includes a first accommodating region adapted for an optical fiber portion of the fiber array unit to extend therethrough; and
said second limit portion includes a second accommodating region adapted for the receptacle portion of the fiber array unit to extend therethrough.

20. The component coupling apparatus as claimed in claim 17, wherein:
said retention mechanism further includes a curing unit;
said curing unit includes a first light source and a second light source;
said first light source is operable to emit ultraviolet light toward said first retention portion of said retention member;
said second light source is operable to emit laser light toward said second retention portion of said retention member.
